(19) United States
(12) Patent Application Publication
(10) Pub. No.: US 2017/0082024 A1
(43) Pub. Date: Mar. 23, 2017

(54) INDEPENDENTLY CONTROLLED THREE STAGE WATER INJECTION IN A DIFFUSION BURNER

(71) Applicant: Siemens Energy, Inc., Orlando, FL (US)

(72) Inventors: Shervin Rodd, Chuluota, FL (US); Gurdev Singh, Orlando, FL (US); Heena H. Dandwani, Orlando, FL (US)

(21) Appl. No.: 14/856,973

(22) Filed: Sep. 17, 2015

(51) Int. Cl. F02C 3/30; F02C 3/22

(52) U.S. Cl. CPC F02C 3/30; F02C 3/22

(57) ABSTRACT

A turbine engine combustion system is disclosed including a fuel nozzle assembly having three independently controlled stages of water injection. A first stage includes water mixed with a gaseous fuel upon inlet to the nozzle, where the first stage water mixes and travels with the gaseous fuel to be injected into a combustor. A second stage includes water injected into the combustor via a secondary liquid nozzle which is used for fuel oil during liquid fuel operation, but which may be used for the secondary water during gaseous fuel operation. A third stage includes water injected into the combustor via a plurality of nozzle holes known as an atomizing air cap. An algorithm and criteria are also defined for controlling the three stages of water injection to achieve the optimum balance of turbine operational criteria including NOx emissions, combustion dynamics and water impingement downstream of the nozzle.

### BACKGROUND OF THE INVENTION

Field of the Invention

The invention generally relates to diffusion flame combustors for turbine engines and more particularly to a nozzle system and a method for supplying water in the form of liquid water to such diffusion flame combustors, where the water is provided to the combustor via three independently controlled injection locations in the nozzle.

Description of the Related Art

The world's energy needs continue to rise—thus creating a demand for reliable, affordable, efficient and environmentally-compatible power generation. A gas turbine engine is one known machine that provides efficient power, and often has application for an electric generator in a power plant, or engines in an aircraft or a ship. A typical gas turbine engine includes a compressor section, a combustion section and a turbine section. The compressor section provides a compressed airflow to the combustion section where the air is mixed with a fuel, such as natural gas. The combustion section includes a plurality of circumferentially disposed combustors that receive the fuel to be mixed with the air and ignited to generate a working gas. The working gas expands through the turbine section and is directed across rows of blades therein by associated vanes. As the working gas passes through the turbine section, it causes the blades to rotate, which in turn causes a shaft to rotate, thereby providing mechanical work.

The temperature of the working gas is tightly controlled so that it does not exceed some predetermined temperature for a particular turbine engine design because too high of a temperature can damage various components in the turbine section of the engine. However, it is desirable to cause the temperature of the working gas to be as high as possible without causing damage—because the higher the temperature of the working gas, the faster the flow of the gas, which results in more efficient operation of the engine.

In one known gas turbine engine design, the combustion section includes a fuel nozzle assembly, a combustor and a transition component, where the fuel nozzle assembly introduces fuel and cooling water into the combustor where it is mixed with air and burned, and the hot combustion gases pass through the transition component into the turbine section. Although the designs of the fuel nozzle assembly, the combustor and the transition component have been well developed over the years, continuous improvements in turbine performance, efficiency and durability are always sought after.

NOx is a genetic term for mono-nitrogen oxides including NO (nitric oxide) and NO₂ (nitrogen dioxide). Turbine combustor development focuses on meeting exhaust NOx emissions without negatively impacting other critical areas that are part of the overall system design. With diffusion flame combustors, water or steam can be injected into the combustor to control NOx emissions. However, injecting water can cause unwanted stability problems in the form of high combustor dynamics and durability issues with respect to liner cracking. The development of such systems requires a delicate balance of these competing design criteria—emissions, dynamics, and hardware life. Flexibility in water injection through the nozzle is key to achieving an optimum balance.

### SUMMARY OF THE INVENTION

In accordance with the teachings of the present invention, a turbine engine combustion system is disclosed including a fuel nozzle assembly having three independently controlled stages of water injection. The intent of introducing water through a third stage is to improve mixing of water with other fluids in the combustor basket. The increased interaction between water jets and external aerodynamic forces promotes early formation of water droplets due to increase in the surface energy of the jets which lowers the surface tension. A first stage includes water mixed with a gaseous fuel upon inlet to the nozzle, where the first stage water mixes and travels with the gaseous fuel to be injected into a combustor. A second stage includes water injected into the combustor via a secondary liquid nozzle which is used for fuel oil during liquid fuel operation, but which may be used for the secondary water during gaseous fuel operation. A third stage includes water injected into the combustor via a plurality of orifice nozzle holes collectively known as an atomizing air cap. The atomizing air cap nozzles are used to atomize the fuel during fuel oil operation ignition to improve start up reliability, and can be used for water injection during gaseous fuel operation. An algorithm and criteria are also defined for controlling the three stages of water injection to achieve the optimum balance of turbine operational criteria including NOx emissions, combustion dynamics and water impingement on the combustor basket walls and the transition piece downstream of the nozzle.

Additional features of the present invention will become apparent from the following description and appended claims, taken in conjunction with the accompanying drawings.

### BRIEF DESCRIPTION OF THE DRAWINGS

FIG. 1 is a cutaway, isometric view of a gas turbine engine of a known design;

FIG. 2 is a partially cutaway side view illustration of one non-limiting embodiment of a multi-functional fuel nozzle with three stage water injection;

FIG. 3 is an end view illustration of the three stage water injection fuel nozzle of FIG. 2;

FIG. 4 is schematic diagram of a water supply and control system connected with the three stage water injection nozzle of FIG. 2; and

FIG. 5 is a flowchart diagram of a method for determining optimum water flow rates for three stage water injection in a gas turbine nozzle and combustor.

### DETAILED DESCRIPTION OF THE EMBODIMENTS

The following discussion of the embodiments of the invention directed to three stage water injection in a diffusion burner for a gas turbine engine is merely exemplary in nature, and is in no way intended to limit the invention or its applications or uses.

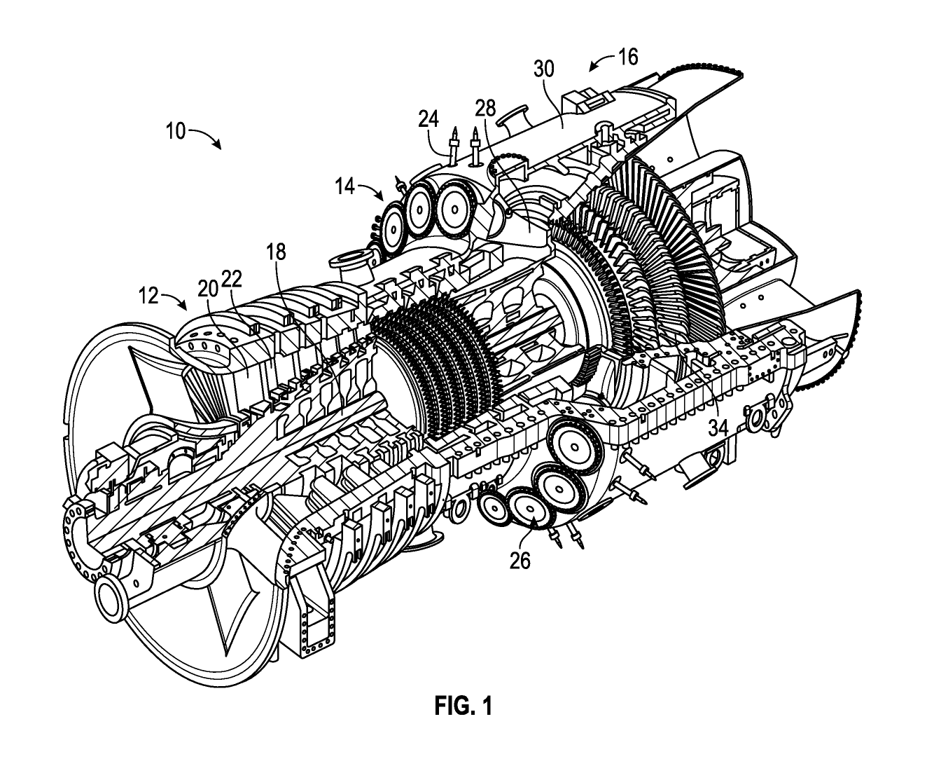

FIG. 1 is a cutaway, isometric view of a gas turbine engine 10 including a compressor section 12, a combustion section 14 and a turbine section 16 all enclosed within an outer housing or casing 30, where operation of the engine 10 causes a central shaft or rotor 18 to rotate, thus creating mechanical work. The engine 10 is illustrated and described by way of a non-limiting example to provide context to the invention discussed below. Those skilled in the art will appreciate that other gas turbine engine designs can also be used in connection with the invention. Rotation of the rotor 18 draws air into the compressor section 12 where it is directed by vanes 22 and compressed by rotating blades 20 to be delivered to the combustion section 14, where the compressed air is mixed with a fuel, such as natural gas, and where the fuel/air mixture is ignited to create a hot working gas. More specifically, the combustion section 14 includes a number of circumferentially disposed combustors 26 each receiving the fuel that is injected into the combustor 26 by an injector or nozzle (not shown), mixed with the compressed air and ignited by an igniter 24 to be combusted to create the working gas, which is directed by a transition component 28 into the turbine section 16. The working gas is then directed by circumferentially disposed stationary vanes (not shown in FIG. 1) in the turbine section 16 to flow across circumferentially disposed rotatable turbine blades 34, which causes the turbine blades 34 to rotate, thus rotating the rotor 18.

It is desirable for gas turbine engines such as the engine 10 to produce very hot combustion gases in order to enhance turbine efficiency. However, very hot combustion gases are known to cause an increase in NOx (oxides of nitrogen) emissions. Injecting water into the turbine combustors 26 via a fuel nozzle is a technique known in the art for controlling combustion gas temperature to reduce NOx emissions and improve component durability. However, the use of water injection is not without its own problems.

Water which is injected into the combustors 26 without proper atomization or vaporization can impinge on combustor basket walls, causing localized thermal shock cooling which may damage the combustor basket wall. Too much water injection can also cause problems with combustion quality in the combustors 26. Furthermore, attempting to inject too much water into the stream of gaseous fuel in the water injection donut (discussed below) can actually cause a back-pressure which restricts fuel flow. For these and other reasons, a nozzle which offers increased flexibility in water injection is desired.

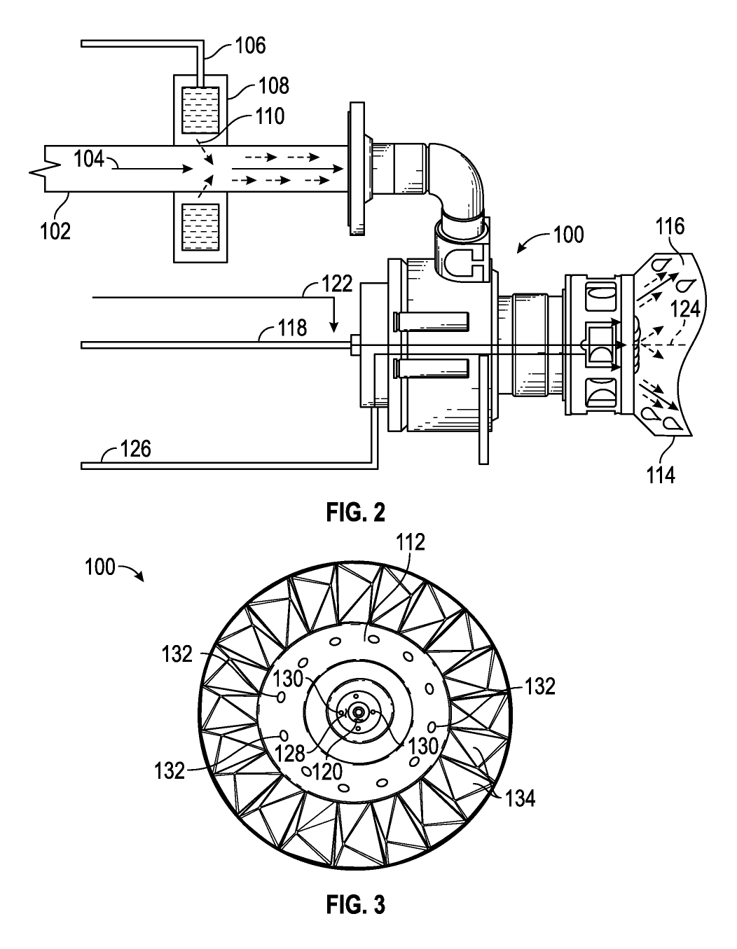

FIG. 2 is a side view illustration of a fuel nozzle assembly 100 for a turbine engine diffusion flame combustor. In accordance with a non-limiting embodiment of the present invention, the nozzle assembly 100 is adapted to provide three stages of water injection. A fuel line 102 supplies a gaseous fuel 104 to the fuel nozzle assembly 100. A primary water line 106 supplies water to a water injection donut 108 coupled to the fuel line 102. The water injection donut 108 can be mounted so as to surround or to encircle the fuel line 102. The water injection donut 108 can facilitate injection of one or more water streams 110 into the fuel 104 flowing through the fuel line 102. The mixture of fuel and water in the fuel line 102 flows through a primary fuel outlet 112 (shown in FIG. 3) where it is ignited in a combustor 114 (which may be the combustor 26 of FIG. 1). The primary fuel outlet 112 includes a plurality of holes 132, disposed in a circular pattern, through which the mixture of gaseous fuel and primary water are provided to the combustor 114.

Additionally, water is injected into a burning flame zone 116 in the combustor 114 downstream of the fuel nozzle assembly 100. Injecting water into both the fuel 104 and the flame zone 116 can provide better control of NOx emissions, and provides flexibility in meeting other turbine operational criteria. As used herein, water refers to its various phases, including liquid or vapor, and combinations of liquid and vapor, and including droplets. Water may be referred herein to alternatively as liquid, vapor or steam. In the nozzle assembly 100, the water injected directly into the flame zone 116 includes a secondary stage and a tertiary stage, as discussed below.

A secondary water line 118 supplies an optional second stage of water injection to the fuel nozzle assembly 100. Specifically, the second stage of water injection, from the secondary water line 118, is provided to a secondary liquid nozzle 120 (FIG. 3). The secondary liquid nozzle 120 is used for second stage water injection when the turbine is operating in gaseous fuel mode, which is the subject of the present invention. The secondary liquid nozzle 120 is used for injection of a liquid fuel—provided by a liquid fuel line 122 instead of the secondary water line 118—when the turbine is operating in liquid fuel mode, which is not the subject of the present invention. The secondary liquid nozzle 120 has a single aperture and is positioned on a centerline 124 of the nozzle assembly 100. The secondary liquid nozzle 120 dispenses secondary water (or alternately, liquid fuel) into the combustor 114 in a hollow cone spray pattern equally distributed about the centerline 124 for effective dispersion in the flame zone 116.

A tertiary water line 126 supplies an optional third stage of water injection to the fuel nozzle assembly 100. Specifically, the third stage of water injection, from the tertiary water line 126, is provided to an atomizing air cap 128 (FIG. 3). The atomizing air cap 128 is used for third stage (tertiary) water injection in the form of multiple water jets when the turbine is operating in gaseous fuel mode, which is the subject of the present invention. The atomizing air cap 128 is used for injection of atomizing air during turbine start-up or primary water injection when the turbine is operating in liquid fuel mode, which is not discussed further herein. The atomizing air cap 128 typically has two or more plain-orifice pressure nozzle holes 130, equally spaced surrounding the secondary liquid nozzle 120, through which it dispenses water in the form of thin water jets into the combustor 114 for dispersion in the flame zone 116.

The secondary water line 118 and the tertiary water line 126 are typically used in combination with the primary water line 106. Logic used in designating total water injection amount—and splits between primary, secondary and tertiary stages—is discussed below. The primary water line 106, the secondary water line 118 and the tertiary water line 126 are typically supplied by the same water source via a water supply and control network, discussed below.

FIG. 3 is an end view illustration of the fuel nozzle assembly 100. FIG. 3 depicts the nozzle assembly 100 as viewed from the right side of FIG. 2, as if viewing the nozzle assembly 100 from within the combustor 114. In FIG. 3, the position and configuration of several items discussed above are clearly visible. At the center of FIG. 3, the secondary liquid nozzle 120 with its single central aperture is visible. Immediately radially outward from the secondary liquid nozzle 120 is the atomizing air cap 128 with its plurality of holes 130. In the example shown in FIG. 3, the atomizing air cap 128 has four of the holes 130. Further radially outward from the atomizing air cap 128 is the primary fuel outlet 112 including its plurality of holes 132. The primary fuel outlet 112 typically has a conical shape (smaller downstream) and is positioned slightly upstream from the secondary liquid nozzle 120 and the atomizing air cap 128. Upstream and downstream refer to the direction of fuel and air flow through the turbine, where downstream is to the right in FIG. 2.

A plurality of swirlers 134 are situated in a circumferential pattern radially outward from the primary fuel outlet 112. The swirlers 134 provide a path for combustion air to enter the combustor 114. The swirlers 134 induce a rotational motion in the combustion air, thus promoting a higher degree of mixing leading to near complete combustion in the combustor 114.

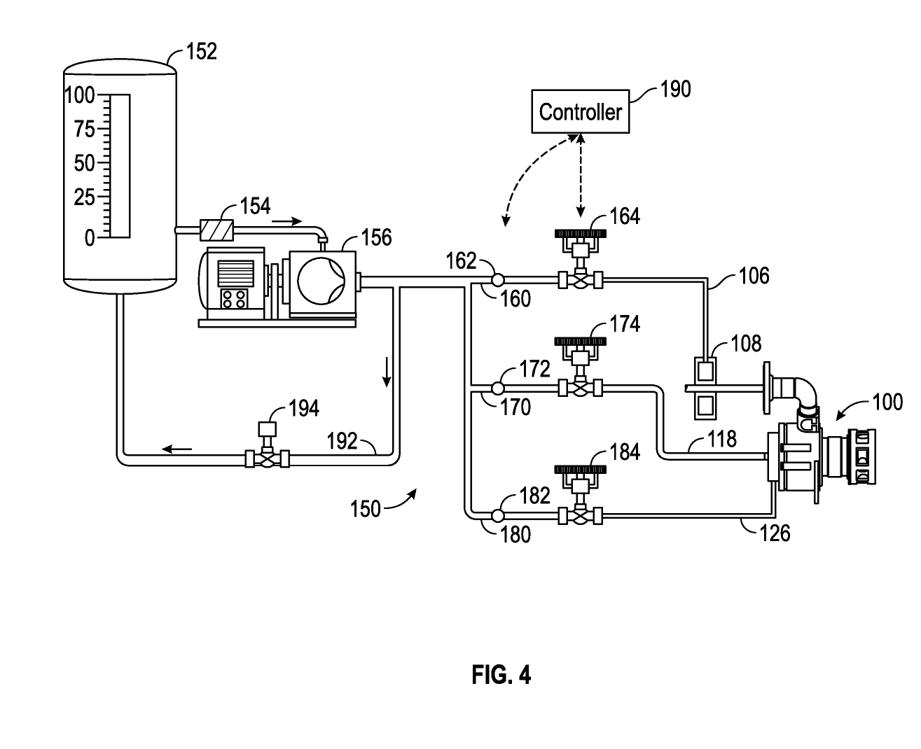

FIG. 4 is a schematic diagram of a water supply and control network 150, combined with the side view of the fuel nozzle assembly 100 of FIG. 2. The water supply and control network 150 provides controlled flows of the primary, secondary and tertiary water to the nozzle assembly 100. The water network 150 includes a water tank 152 which contains a supply of demineralized water or other water of a suitable quality for turbine combustor injection. Water from the tank 152 flows through a filter 154 to a pump 156 which increases the water pressure to a level needed for combustor injection. Downstream of the pump 156, the water network branches into primary, secondary and tertiary lines.

A water line 160 includes a primary flow meter 162 and a primary water injection throttle valve 164 which are used to provide a controlled flow of primary (stage I) injection water to the primary water line 106. As shown in FIG. 2 and discussed previously, the primary water line 106 provides water to the water injection donut 108 where it is mixed with the gas fuel 104. A water line 170 includes a secondary flow meter 172 and a secondary water injection throttle valve 174 which are used to provide a controlled flow of secondary (stage II) injection water to the secondary water line 118. As shown in FIG. 2 and discussed previously, the secondary water line 118 provides water to the secondary liquid nozzle 120 which dispenses the secondary water into the combustor 114. A water line 180 includes a tertiary flow meter 182 and a tertiary water injection throttle valve 184 which are used to provide a controlled flow of tertiary (stage III) injection water to the tertiary water line 126. As shown in FIG. 2 and discussed previously, the tertiary water line 126 provides water to the atomizing air cap 128, which dispenses the tertiary water into the combustor 114.

A controller 190 is in communication with the flow meters 162/172/182 and the throttle valves 164/174/184, where the controller 190 controls the opening position of the throttle valves 164/174/184 to establish the desired flow rates of primary, secondary and tertiary injection water. Determination of the desired flow rates, for any turbine load point, is discussed below. A water return line 192 and a water return valve 194 allow for recirculation of water, provided by the pump 156 but not consumed by the water lines 160/170/180, to the tank 152.

As discussed previously, achieving all turbine operational performance criteria can be a difficult balance, particularly during high load operations. The three stage water injection capability of the nozzle system 100 together with the water supply and control network 150 provides increased flexibility and capability to achieve the required balance. A turbine engine, such as the turbine engine 10, can be operated at a wide range of load points, from very low load (about 10%) to maximum load (100%). The total amount of water injection varies with the load point, where higher load points require more water in proportion to fuel (expressed as water:fuel ratio or W:F). Similarly, the proportional splits between primary, secondary and tertiary water also change as a function of load point, where low load points may exhibit satisfactory performance using only primary water, and high load points may require all three stages of water injection.

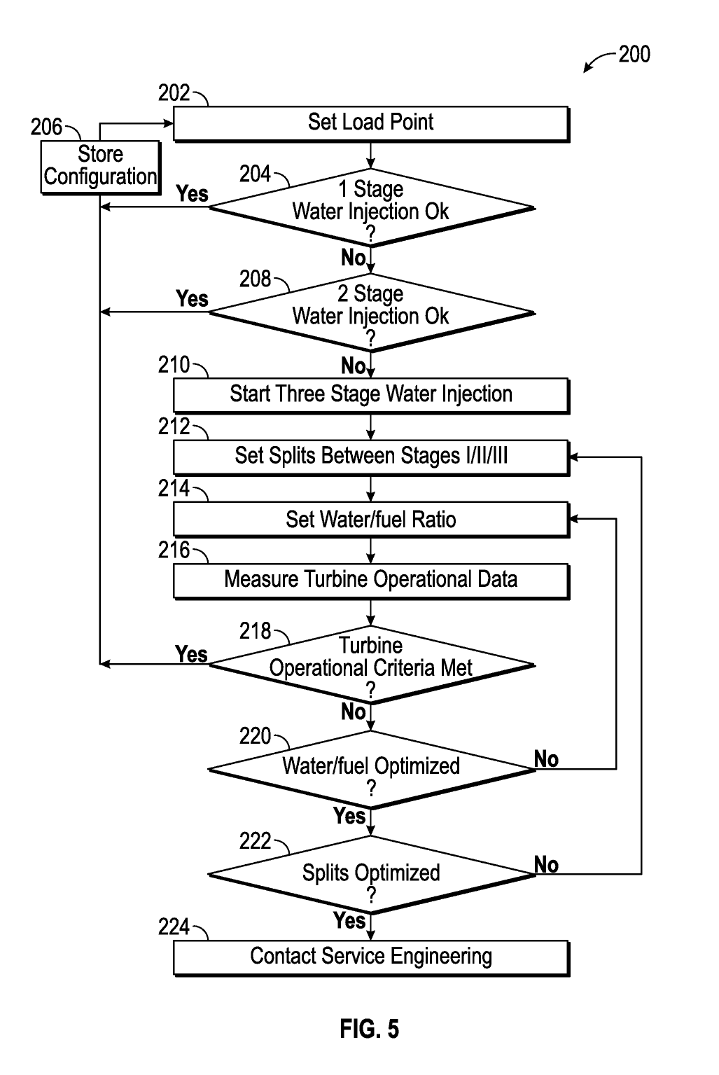

FIG. 5 is a flowchart diagram 200 of a method for determining optimum water flow rates for three stage water injection in a gas turbine nozzle and combustor. The method of the flowchart diagram 200, known as a tuning process, determines the optimum three stage water injection rates for each load point over the full range of turbine loads. This tuning process can be performed when a new turbine is put in service, or when a turbine is returned to service after a maintenance procedure. As a result of the tuning process, the primary, secondary and tertiary water flow rates for each load point are stored as settings in the controller 190, and these water flow settings are used during normal turbine operations to establish water flow rates based on a current operational load point.

In order to run the tuning process of the flowchart diagram 200, the turbine which is being “tuned” (determining optimum water injection rates) must be instrumented with a variety of sensors to collect data. This includes temperature sensors (thermocouples) and combustor pressure sensors which are not typically installed for normal operations of the turbine, along with items such as fuel flow sensors and NOx emissions sensors which are used during normal operations of the turbine. In the tuning process of the flowchart diagram 200, when water flow rate parameters are set to certain values, they are set to these values for all of the nozzles in the turbine—that is, for example, for the nozzle for each of the combustors 26 in the turbine 10 of FIG. 1.

At box 202, the turbine which is being tuned is set to a first load point, such as 10% of peak power. In the subsequent steps, the optimum water injection parameters for the 10% load point will be determined and stored, in a look-up table or other firmware setting used by the controller 190, and then the turbine will be set to the next load point (such as 20%). At decision diamond 204, conventional tuning processes are used to determine whether single stage water injection (via the primary water line 106, mixing water with the gaseous fuel 104) is satisfactory in meeting operational criteria. At a low load point such as 10% where not a lot of water injection is needed in order to control NOx emissions, it may be the case that a simple single stage of water injection is satisfactory. In that case, the optimum water:fuel ratio (W:F) for single stage water injection at the load point will be determined. This can be determined using existing known processes, or using the techniques discussed below for three stage water injection. At box 206, if single stage injection is satisfactory at the decision diamond 204, the configuration parameters for the current load point are stored (for example, primary water only, at a particular W:F ratio or flow rate), and the process returns to the box 202 to where the turbine is set to the next load point.

If, at the decision diamond 204, it is determined that single stage water injection is not satisfactory to meet operational criteria, then at decision diamond 208, conventional tuning processes are used to determine whether two stage water injection (via the primary water line 106 and the secondary water line 118) is satisfactory in meeting operational criteria. For example, at a load point such as 40% where a moderate amount of water injection is needed in order to control NOx emissions, it may be the case that two stages of water injection are satisfactory. In that case, the optimum water:fuel ratio (W:F) for two stage water injection, along with the splits between stage I (the primary water line 106) and stage II (the secondary water line 118), at the load point will be determined. These can be determined using existing known processes, or using the techniques discussed below for three stage water injection. At box 206, if two stage injection is satisfactory at the decision diamond 208, the configuration parameters for the current load point are stored (for example, overall W:F ratio, and split between stage I and stage II), and the process returns to the box 202 to where the turbine is set to the next load point.

If, at the decision diamond 208, it is determined that two stage water injection is not satisfactory to meet operational criteria, then three stage water injection is initiated at box 210. As discussed previously, at high load points (above 60% for example), it is possible that the amount of water injection needed for NOx abatement begins to cause detrimental effects in other aspects of turbine performance if the water injection is limited to two stages. This situation is where three stage water injection provides the flexibility and capability to achieve a better balance of all operational criteria.

At box 212, the splits between stage I (the primary water line 106), stage II (the secondary water line 118) and stage III (the tertiary water line 126) are established for the current load point. When the box 212 is first encountered after initiation of three stage injection, the splits can be set to default values—such as 40% stage I, 40% stage II and 20% stage III (these values are given merely as examples). At box 214, the overall W:F ratio is set for the current load point. Again, a default W:F ratio may be set for the first iteration at any given load point. At box 216, turbine operational data is measured by a number of different sensors fitted to the turbine. These may include, for example, a fuel flow rate sensor (for each of the nozzles in the turbine), water flow rate sensors (for each water line for each nozzle), combustor wall/liner temperature (for each of the combustors), combustion gas pressure (for each of the combustors), combustion gas temperature and/or component temperature at various circumferential positions around the turbine stage, and a NOx emissions sensor.

At decision diamond 218, it is determined whether turbine operational performance criteria are met when running with the current values of W:F ratio and splits at the current load point. Several different operational criteria may be considered at the decision diamond 218. These are discussed below, along with their implications on injection water flow rates.

A first operational criteria considered at the decision diamond 218 is whether the fuel gas throttle valve is in control. The gas throttle valve is a valve in the fuel line 102 used to throttle the flow of the gaseous fuel 104. The valve flow vs. position characteristic curve of the valve indicates the position of the valve for a given reference flow set point. The valve is considered to be out of control if the non-linearity between the flow and the position becomes very high; i.e. for a small increase in flow the valve stem displacement becomes very high and reaches maximum limit and loses its capability to reduce error between the reference flow set point and the actual flow. Such an out of control situation may arise from too much primary water being injected via the water injection donut 108, where the high water flow creates a restriction to gas flow and causes back pressure in the fuel line 102. In this case, the amount of primary water injection must be reduced (necessitating an increase in secondary and/or tertiary water injection) in order to regain control of the gas throttle valve.

A second operational criteria considered at the decision diamond 218 is whether NOx emissions are in compliance. Regulations typically require NOx emissions to remain below a prescribed value—such as a concentration of 25 parts per million (PPM) in the turbine exhaust. If NOx emissions are too high, among other things this is an indication that local combustion gas temperatures are too high, thus requiring an increase in water injection. In this case, the overall W:F ratio likely needs to be increased.

A third operational criteria considered at the decision diamond 218 is whether liquid water is impinging on the combustor wall. In high water injection flow situations, it is possible for bulk water coming out of the nozzle assembly 100 not to atomize fully and diffuse with the air/fuel mixture in the flame zone 116. As such, there is a risk of water droplets impinging the wall of the combustor 114; this is undesirable as it can lead to thermal distress in the combustor wall. Water impingement can be detected by placing thermocouples on the combustor walls and monitoring for cool spots. In the case of combustor wall water impingement, the overall W:F ratio should be decreased (if possible without violating NOx emissions constraints), or the stage I/II/III splits should be adjusted.

A fourth operational criteria considered at the decision diamond 218 is whether turbine blade path temperatures are within an acceptable range. In the turbine section 16 of the turbine 10, thermocouples are placed at many circumferential locations. For example, if the turbine 10 includes 14 of the combustors 26, then 14 thermocouples may be placed circumferentially around a turbine stage, where the temperature reading from each thermocouple can be associated with a particular one of the combustors 26. Note that the thermocouples may not reflect the conditions in the combustor 26 which is directly axially aligned with them, but rather may reflect the conditions in a combustor 26 which is at a different circumferential position due to “swirl” of the combustion gases as they flow along the turbine axis. Blade path temperature spreads identify the difference between the minimum and maximum temperature reading of any of the thermocouples and the average temperature reading of all of the thermocouples. A blade path temperature spread which identifies a turbine blade path location significantly cooler than average is indicative of one or more combustors burning lean or receiving too much water, and therefore reaching a flame out condition. A blade path temperature spread which identifies a turbine blade path location significantly hotter than average is normally indicative of hardware breach/rupture in one or more of the fuel nozzles 100. Water injection strategies vary depending on whether blade path temperature spreads indicate cool spots or hot spots.

A fifth operational criteria considered at the decision diamond 218 is whether combustor dynamics are within an acceptable range. Pressure oscillations in and downstream of the combustors 26 are also called combustor dynamics, and are normally an outcome of unsteadiness in the combustion process, which may also be due to flame instability. Pressure sensors are used to measure combustor dynamics. Excessive combustor dynamics may be an indication of too much water being injected, and are unacceptable as the pressure oscillations may cause damage to the turbine. Water injection may need to be reduced or re-balanced between the three stages if excessive combustor dynamics are detected.

If not all of the operational performance criteria discussed above are satisfactory, then at decision diamond 220 it is determined whether the W:F ratio is optimized. If the W:F ratio is not optimized, then the process loops back to the box 214 where the W:F ratio is set to a new value, the turbine is allowed to reach steady state with the new W:F ratio, and data is again measured at the box 216 and evaluated at the decision diamond 218.

If the W:F ratio is optimized at the decision diamond 220, then at decision diamond 222 it is determined whether the water injection splits between stages I/II/III are optimized. If the splits are not optimized, then the process loops back to the box 212 where the splits are set to new values, W:F ratio is left as previously set at the box 214, the turbine is allowed to reach steady state with the new splits, and data is again measured at the box 216 and evaluated at the decision diamond 218. The W:F ratio and the splits may be iteratively adjusted in the two nested loops until they are optimized and all turbine operational criteria are met.

If the W:F ratio is optimized at the decision diamond 220 and the water injection splits are optimized at the decision diamond 222 but the turbine operational criteria are still not met at the decision diamond 218, then there is nothing else that can be done with water injection to meet the turbine operational criteria. In that case, the service engineering department is contacted at box 224 to evaluate the turbine's condition, and some service or maintenance procedure may be needed.

The evaluation of all of the performance criteria discussed above, and the iterative setting of W:F ratio and splits, may be performed manually by an experienced tuning engineer, or may be performed by an algorithm which has been programmed based on knowledge captured from such a tuning engineer.

When the turbine operational criteria are determined to be satisfactory at the decision diamond 218, the three stage injection configuration parameters for the current load point are stored at the box 206 (for example, overall W:F ratio, and split between stages I/II/III), and the process returns to the box 202 to where the turbine is set to the next load point. The process ends after the optimum water injection configuration parameters are stored for the 100% load point.

After the tuning process of the flowchart diagram 200 is completed for all load points up to and including 100%, the turbine can be put into normal operational service and the stored data (overall W:F, and splits) can be used to establish the desired three stage water flow rates for any given load point. In other words, during normal operations of the turbine, the tuning process of the flowchart diagram 200 is not used; the controller 190 simply uses the stored values of W:F and splits for the current turbine load point, and sets the throttle valves 164/174/184 to establish the desired water flow rates for all three stages of water injection.

The systems and method described above, which provide independently controlled three stage water injection in a turbine combustor, offer greater flexibility in meeting turbine operational and performance criteria. In particular, the three stage water injection enables NOx-compliant turbine operation at high load points where conventional single stage or two stage water injection systems would encounter problems with combustion quality, water impingement or fuel flow.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A combustion system for a turbine engine, said combustion system comprising:
a combustion chamber;
a fuel nozzle assembly having a primary fuel outlet configured to provide a gaseous fuel into the combustion chamber where the gaseous fuel combusts in a flame zone, a secondary liquid nozzle configured to spray a secondary liquid into the flame zone, and an atomizing air cap configured to spray water into the flame zone;
a gaseous fuel line in fluid communication with the primary fuel outlet for supplying the gaseous fuel to the primary fuel outlet;
a primary water line, in fluid communication with the gaseous fuel line, which supplies primary water to mix with the gaseous fuel in the gaseous fuel line upstream of the primary fuel outlet;
a secondary water line, in fluid communication with the secondary liquid nozzle, which supplies secondary water to the flame zone through the secondary liquid nozzle; and
a tertiary water line, in fluid communication with the atomizing air cap, which supplies tertiary water to the flame zone through the atomizing air cap,
where flow rates of the primary water, the secondary water and the tertiary water are controlled by a water supply system, located upstream of the fuel nozzle assembly, to optimize performance of the turbine engine.

2. The combustion system of claim 1 wherein the water supply system includes a controller which is configured to control three throttle valves, one of the throttle valves located on each of the primary water line, the secondary water line and the tertiary water line, where the controller controls the throttle valves to achieve the flow rates of the primary water, the secondary water and the tertiary water as prescribed in a look-up table as a function of turbine load percentage.

3. The combustion system of claim 2 wherein the look-up table is populated in a tuning process which is performed before the turbine engine is placed into regular service, where the tuning process includes setting the turbine engine to a load point, determining a water/fuel ratio and primary/secondary/tertiary water fractions which optimize turbine engine performance based on a plurality of criteria at the load point, and setting the turbine engine to a subsequent load point.

4. The combustion system of claim 3 wherein the plurality of criteria include an ability of a fuel gas throttle valve to control a flow of the gaseous fuel to the fuel nozzle assembly, a concentration of oxides of nitrogen (NOx) emissions in exhaust gas from the turbine engine, a presence of water impingement on walls of the combustion chamber, an amount of variance between temperatures measured at multiple circumferential locations in a turbine section of the turbine engine, and frequency and amplitude of oscillations in combustion gas pressure in the combustion chamber.

5. The combustion system of claim 1 wherein the secondary water and the tertiary water are not used if the performance of the turbine engine can be optimized with only the primary water, and the tertiary water is not used if the performance of the turbine engine can be optimized with only the primary water and the secondary water.

6. The combustion system of claim 1 wherein the secondary liquid nozzle has a single nozzle aperture, located on a centerline of the fuel nozzle assembly, which sprays the secondary liquid into the flame zone in a hollow cone spray pattern.

7. The combustion system of claim 6 wherein the atomizing air cap has a plurality of apertures, located in an equally spaced circumferential pattern surrounding the secondary liquid nozzle, which spray the tertiary water into the flame zone.

8. The combustion system of claim 7 wherein the primary fuel outlet has a plurality of apertures, located in an equally spaced circumferential pattern surrounding the atomizing air cap, which provide the gaseous fuel and the primary water into the combustion chamber.

9. The combustion system of claim 1 wherein the combustion system is adapted to operate in an alternate mode where the primary fuel outlet and the gaseous fuel are not used, the secondary liquid sprayed by the secondary liquid nozzle is a liquid fuel which combusts in the flame zone, and the atomizing air cap supplies the only water to the flame zone, where the liquid fuel is supplied by a liquid fuel line which is in fluid communication with the secondary liquid nozzle in place of the secondary water line.

10. A water/fuel injection system for a turbine engine, said injection system comprising:
a fuel nozzle assembly having a primary fuel outlet configured to provide a gaseous fuel into a combustion chamber where the gaseous fuel combusts in a flame zone, a secondary liquid nozzle configured to spray a secondary liquid into the flame zone, and an atomizing air cap configured to spray water into the flame zone;
a gaseous fuel line in fluid communication with the primary fuel outlet for supplying the gaseous fuel to the primary fuel outlet;
a primary water line including a throttle valve, in fluid communication with the gaseous fuel line, which supplies primary water to mix with the gaseous fuel in the gaseous fuel line upstream of the primary fuel outlet;
a secondary water line including a throttle valve, in fluid communication with the secondary liquid nozzle, which supplies secondary water to the flame zone through the secondary liquid nozzle;
a tertiary water line including a throttle valve, in fluid communication with the atomizing air cap, which supplies tertiary water to the flame zone through the atomizing air cap;
a pump for providing pressurized water to the primary water line, the secondary water line and the tertiary water line; and
a controller in communication with the throttle valves, where flow rates of the primary water, the secondary water and the tertiary water are controlled by the controller to optimize performance of the turbine engine.

11. The injection system of claim 10 wherein the secondary water and the tertiary water are not used if the performance of the turbine engine can be optimized with only the primary water, and the tertiary water is not used if the performance of the turbine engine can be optimized with only the primary water and the secondary water.

12. The injection system of claim 10 wherein the controller is configured to control the throttle valves to achieve the flow rates of the primary water, the secondary water and the tertiary water as prescribed in a look-up table as a function of turbine load percentage.

13. The injection system of claim 12 wherein the look-up table is populated in a tuning process which is performed before the turbine engine is placed into regular service, where the tuning process includes setting the turbine engine to a load point, determining a water/fuel ratio and primary/secondary/tertiary water fractions which optimize turbine engine performance based on a plurality of criteria at the load point, and setting the turbine engine to a subsequent load point.

14. The injection system of claim 13 wherein the plurality of criteria include ability of a fuel gas throttle valve to control a flow of the gaseous fuel to the fuel nozzle assembly, concentration of oxides of nitrogen (NOx) emissions in exhaust gas from the turbine engine, presence of water impingement on walls of the combustion chamber, amount of variance between temperatures measured at multiple circumferential locations in a turbine section of the turbine engine, and frequency and amplitude of oscillations in combustion gas pressure in the combustion chamber.

15. A method for determining water flow rates for three stage water injection in a turbine engine combustion system, said method comprising:
providing a turbine engine with injection of primary water,
secondary water and tertiary water in the combustion system;
setting the turbine engine to operate at a load point and measuring turbine operational data;
determining if a plurality of turbine operational criteria are satisfied at the load point using single stage water injection or two stage water injection in the combustion system using the operational data;
starting three stage water injection if the turbine operational criteria are not satisfied at the load point using single stage water injection or two stage water injection;
setting primary/secondary/tertiary water fractions to preliminary values for the load point;
setting water/fuel ratio to a preliminary value for the load point;
operating the turbine engine using the water/fuel ratio and the primary/secondary/tertiary water fractions and measuring the turbine operational data;
determining if the plurality of turbine operational criteria are satisfied using the operational data;
determining if the water/fuel ratio is at an optimal value to satisfy the operational criteria, and if not, setting the water/fuel ratio to a new value and returning to the operating the turbine engine step;
determining if the water fractions are at optimal values to satisfy the operational criteria, and if not, setting the water fractions to new values and returning to the operating the turbine engine step; and
storing the water/fuel ratio and the water fractions for the load point in a look-up table, and setting the turbine engine to operate at a new load point, when the operational criteria are satisfied and the water/fuel ratio and the water fractions are optimized.

16. The method of claim 15 wherein the plurality of criteria include an ability of a fuel gas throttle valve to control a flow of a gaseous fuel to the combustion system, a concentration of oxides of nitrogen (NOx) emissions in exhaust gas from the turbine engine, a presence of water impingement on walls of a combustion chamber, an amount of variance between temperatures measured at multiple circumferential locations in a turbine section of the turbine engine, and frequency and amplitude of oscillations in combustion gas pressure in the combustion chamber.

17. The method of claim 15 wherein the combustion system includes a fuel nozzle assembly configured to inject fuel into a combustion chamber along with the primary water, the secondary water and the tertiary water, and where a controller in a water supply system controls flow rates of the primary water, the secondary water and the tertiary water to obtain the water/fuel ratio and the primary/secondary/tertiary water fractions.

18. The method of claim 17 wherein the fuel nozzle assembly includes:
a primary fuel outlet configured to provide a gaseous fuel into the combustion chamber where the gaseous fuel combusts in a flame zone, a secondary liquid nozzle configured to spray a secondary liquid into the flame zone, and an atomizing air cap configured to spray water into the flame zone;
a gaseous fuel line in fluid communication with the primary fuel outlet for supplying the gaseous fuel to the primary fuel outlet;
a primary water line, in fluid communication with the gaseous fuel line, which supplies primary water to mix with the gaseous fuel in the gaseous fuel line upstream of the primary fuel outlet;
a secondary water line, in fluid communication with the secondary liquid nozzle, which supplies secondary water to the flame zone through the secondary liquid nozzle; and
a tertiary water line, in fluid communication with the atomizing air cap, which supplies tertiary water to the flame zone through the atomizing air cap.

19. The method of claim 18 wherein the water supply system includes a pump for providing pressurized water to the primary, secondary and tertiary water lines, and a throttle valve in each of the water lines, where the controller controls the position of the throttle valves to obtain the water/fuel ratio and the primary/secondary/tertiary water fractions.

20. The method of claim 17 wherein the method is performed before the turbine engine is placed into regular service, and the look-up table is used by the controller to control flow rates of the primary water, the secondary water and the tertiary water during regular service operation of the turbine engine.
